(19) United States
(12) Patent Application Publication
(10) Pub. No.: US 2025/0163729 A1
(43) Pub. Date: May 22, 2025

(54) DOGGING MECHANISM FOR EXIT DEVICES

(71) Applicant: ASSA ABLOY Accessories and Door Controls Group, Inc., New Haven, CT (US)

(72) Inventors: Michael Connell, Connellsville, PA (US); Matthew Donaldson, Meyersdale, PA (US); Kyle R. Murray, Somerset, PA (US); Sam Wiedner, Friedens, PA (US)

(73) Assignee: ASSA ABLOY Accessories and Door Controls Group, Inc., New Haven, CT (US)

(21) Appl. No.: 18/938,675

(22) Filed: Nov. 6, 2024

Related U.S. Application Data
(60) Provisional application No. 63/601,458, filed on Nov. 21, 2023.

(51) Int. Cl. E05B 65/10

(52) U.S. Cl. CPC E05B 65/1093

(57) ABSTRACT

A dogging mechanism for an exit device may include a camming element that is configured to rotate between an undogged position and a dogged position. The dogging mechanism may include a first linkage operatively coupled to a latch of the exit device and a second linkage operatively coupled to the camming element. The first linkage may be fixed to the camming element such that movement of the camming element between the undogged position and the dogged position moves the latch between a latched position and an unlatched position, respectively. The camming element may include at least one slot that is at least partially curved, and the slot may receive a pin of the second linkage such that the slot is movable relative to the second linkage to move the camming element between the undogged and dogged positions.

### CROSS-REFERENCE TO RELATED APPLICATIONS

This application claims the benefit under 35 U.S.C. § 119(e) to U.S. Provisional Application Ser. No. 63/601,458, entitled “DOGGING MECHANISM FOR EXIT DEVICES,” filed on Nov. 21, 2023, which is hereby incorporated by reference in its entirety.

### FIELD

Disclosed embodiments are related to exit devices and more particularly dogging mechanisms configured for use with exit devices.

### BACKGROUND

Conventional exit devices typically employ a dogging mechanism which may be used to hold the exit device in an unlatched configuration such that the door latch is prevented from engaging an associated door strike. These dogging mechanisms are typically used where it is desirable to keep doors open for both push and pull without actuation of the latch.

### SUMMARY

In some embodiments, a dogging mechanism for an exit device may include a camming element configured to move between a dogged state and an undogged state, and at least one slot in the camming element configured to permit movement of the camming element between the dogged and undogged states. The dogging mechanism may also include a first linkage operatively coupled to a latch of the exit device, where the first linkage is also fixed to the camming element such that movement of the camming element between the undogged and dogged states moves the latch between a latched position and an unlatched position, respectively. The dogging mechanism may also include a second linkage operatively coupled to the camming element, where the second linkage includes a pin that may be received within the at least one slot of the camming element. The at least one slot may be curved to permit rotation of the camming element, and the camming element may be configured to move between the undogged and dogged states by moving the at least one slot relative to the second linkage.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of one embodiment of a glass door including an exit device;

FIG. 2A is a front schematic view of an upper section of an exit device having a latch, according to some embodiments;

FIG. 2B is a front schematic view of a lower section of the exit device of FIG. 2A, according to some embodiments;

FIG. 2C is a top schematic sectional view of a dogging mechanism configured for use with the exit device of FIGS. 2A-B taken along lines 2C-2C, according to some embodiments;

FIG. 3A is a side schematic view of the upper section of the exit device of FIG. 2A where the dogging mechanism is shown in an undogged state, according to some embodiments;

FIG. 3B is a side schematic view of the lower section of the exit device of FIG. 2B where the dogging mechanism is shown in an undogged state, according to some embodiments;

FIG. 3C is an enlarged view of region 3C of FIG. 3B, according to some embodiments;

FIG. 4A is a side schematic view of the upper section of the exit device of FIG. 2A where the dogging mechanism is shown in a dogged state, according to some embodiments;

FIG. 4B is a side schematic view of the lower section of the exit device of FIG. 2B where the dogging mechanism is shown in a dogged state, according to some embodiments; and

FIG. 4C is an enlarged view of region 4C of FIG. 4B, according to some embodiments.

### DETAILED DESCRIPTION

Exit devices are commonly found throughout commercial, residential, and industrial buildings and may include push bars which are depressible by a user to open associated doors. Conventional exit devices may employ a dogging mechanism to dog the exit device such that the exit device is held in an unlatched position. It may be desirable to place the exit device in a dogged state during business hours or particularly high traffic times in order to reduce potential congestion at entry and exit points for users by keeping doors unlatched for both push and pull without actuation of the exit device. However, in conventional exit devices, it is typical that a push bar of the exit device needs to be depressed in order to simultaneously dog the exit device. These exit devices may often also require use of a dogging button which is then depressed to retain the exit device in the unlatched position. In particular, dogging buttons are often employed as it may be inconvenient to employ a key or other tool (e.g., an Allen wrench) to put the exit device in a dogged state while ensuring that the push bar remains depressed.

In view of the above, the inventors have recognized benefits associated with providing an exit device including a dogging mechanism that is able to be dogged without depression of a push bar of the exit device.

Such an arrangement may allow a user to employ a key or other tool to dog an interior side of the exit device rather than requiring a dogging button to be depressed on a push bar. Specifically, a user may insert a tool into a dogging mechanism of the exit device and the user may rotate and/or translate the tool within a slot of the dogging mechanism without needing to depress the push bar of the exit device, thus allowing for a latch of the exit device to be retained in an unlatched position when in the dogged state. As discussed further below, in some embodiments, the dogging mechanism may include a camming element that is configured to transition between a dogged state and an undogged state to correspondingly dog or undog the exit device, respectively, in response to the user input.

In the dogged state, the dogging mechanism may be configured to hold a latch of the exit device in an unlatched position such that an associated door may be pushed or pulled open without being inhibited by the exit device. Accordingly, in the undogged state, the exit device may be configured to latch an associated door closed such that a push bar has to be depressed to retract the latch into an unlatched position.

In some embodiments, the dogging mechanism may include a camming element as noted above. In some embodiments, the camming element may include a slot configured to receive a key (or other tool), and the user may turn the key within the slot to rotate the camming element between the undogged state and the dogged state to move a corresponding latch of the exit device between a latched position and an unlatched position, respectively. In some embodiments, the dogging mechanism may include a dogging actuator to rotate the camming element as the disclosure is not so limited. For example, the dogging actuator may be configured to receive the input from the user (e.g., the key) and in turn transfer motion to the camming element, e.g., via any suitable mechanical coupling to the camming element including gears, linkages, or any other suitable type of coupling.

In some embodiments, the exit device may include a singular latch that is moveable between a latched position and an unlatched position, where the latch is engageable with a corresponding door strike when the latch is in a latched position. For example, the latch of the exit device may be configured to engage a door strike located in the head jamb of a door. In addition or alternatively, the exit device may include a plurality of latches that are moveable between a latched position and an unlatched position. For example, the plurality of latches may include two latches that are configured to engage a door strike located in each of the head jamb and the threshold. While such examples are disclosed, the exit device may include any suitable arrangement of latches (e.g., a head jamb latch, a threshold latch, a side jamb latch, etc.) to engage with corresponding portions of a door (e.g., a head jamb, a threshold, a side jamb, etc.).

In some embodiments, the dogging mechanism disclosed herein may include a camming element, a first linkage, and a second linkage, where each of the first and second linkages may be operatively coupled to the camming element. In some such embodiments, the first linkage may also be operatively coupled to a latch of the exit device such that movement of the first linkage moves the latch. For example, the first linkage may be an upper linkage that is fixed to the camming element, and rotation of the camming element between an undogged state and a dogged state may cause the first linkage to move vertically downwards to in turn disengage the latch from a corresponding head jamb of a door. While this example is disclosed, the exit device may be oriented in any suitable fashion such that movement of the first linkage can in turn move a latch of the exit device between a latched position and an unlatched position, thereby disengaging the latch from a corresponding portion of a door. For example, the exit device may be oriented in a horizontal direction such that the rotation of the camming element between an undogged state and a dogged state may disengage a latch of the exit device from a side jamb of a door.

In some embodiments, the camming element may include at least one slot that is configured to engage with at least one pin of the second linkage to permit rotation of the camming element. For example, the camming element may include a singular slot that is at least partially curved and engaged with a pin of the second linkage, thus allowing the camming element to rotate between the dogged state and the undogged state by moving the at least one slot relative to the second linkage. In some such embodiments, the second linkage may be constructed and arranged to remain stationary while the camming element is rotated. Once the camming element is rotated to the dogged state, the latch of the exit device may be retained in the unlatched position to allow for push and pull of the door without actuation of the exit device.

In some embodiments, the camming element may also include a straight slot (e.g., a vertical slot) which is configured to receive an input from the user such as a key to rotate the camming element between an undogged state and a dogged state. In some such embodiments, movement of the camming element may be constrained to translation of the slot relative to the key input by the user when the camming element is in the undogged state. That is, depression of a push bar of the exit device may result in a second, lower linkage pulling the camming element and a first, upper linkage that is fixed to the camming element vertically downwards, thereby moving a latch of the exit device from the latched position to the unlatched position. In the undogged state, when the depression on the push bar is removed, the lower linkage may remove the downwards force on the camming element and first linkage such that the latch is returned to the latched position.

In some embodiments, the camming element may be rotated to any suitable angle such that the exit device is dogged and the at least one latch is retained in the unlatched position. A suitable angle of rotation of the camming element may be greater than or equal to 30 degrees, 45 degrees, 60 degrees, 75 degrees, 90 degrees, 105 degrees, 120 degrees, 135 degrees, 150 degrees, or greater. Suitable angles of rotation may be greater or lesser than those notes above as the disclosure is not so limited.

In some embodiments, the camming element may include a built-in stopping surface that is configured to limit rotation of the camming element. For example, the stopping surface of the camming element may be configured to abut a protuberance of the housing at a suitable angle to prevent further rotation of the camming element once the latch is in the unlatched position. The stopping surface of the camming element and/or protuberance of the housing may be constructed and arranged to be of any suitable shape, size, or other characteristic as the disclosure is not so limited. For example, the stopping surface may be flat or curved (e.g., a hook shape). Likewise, the protuberance of the housing may be of a complementary or non-complementary shape to that of the stopping surface, e.g., the protuberance may be flat, curved, or any other suitable shape. For example, the stopping surface may be hook-shaped while the protuberance may include a recess configured to receive the hook. In some embodiments, the housing itself may include a recessed portion instead of a protuberance extending from a portion of the housing, and the stopping surface of the camming element may be configured to abut the recessed portion to limit rotation of the camming element.

In some embodiments, the camming element, the first linkage, the second linkage, and/or other components of the exit device (e.g., push bar chassis, dogging mechanism housing, etc.) could be constructed out of any suitable material as the disclosure is not so limited. For example, these components may be constructed out of a metal material such as aluminum, carbon steel, stainless steel, iron, bronze, or alloys. Without wishing to be bound by theory, such components may be also constructed out of non-metal materials such as hard plastics.

While the embodiments disclosed herein are primarily described in reference to a camming element which is configured to rotate to dog the exit device, any suitable arrangement may be used to transfer rotational motion resulting from a user input (e.g., a key or other tool to dog the exit device) to linear motion of the latch (e.g., to move the latch to the unlatched position). For example, a series of linkages may be used instead of a camming element, and a user may provide an input to a dogging actuator which may then rotate at least a subset of the series of linkages to in turn move the latch of the exit device to the unlatched position.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

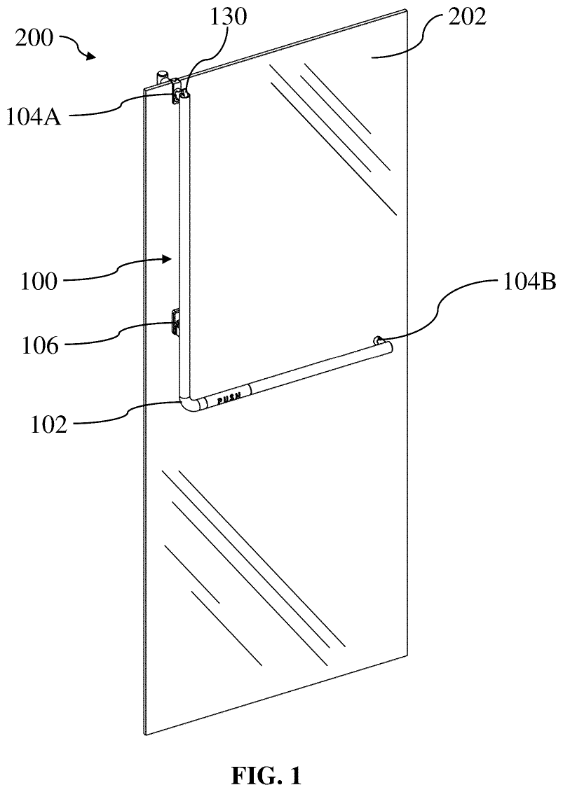

FIG. 1 is a perspective view of an embodiment of a door 200 including an exit device 100. As shown in FIG. 1, the exit device is a low profile exit device which does not substantially obscure a glass panel 202 which forms the glass door. The exit device includes a first hinge 104A, a second hinge 104B, and a door actuator 106 which function as interfacing points between the exit device and the door, so that the majority of the glass panel remains uncovered. A push bar chassis 102 is suspended from the first hinge and the second hinge and serves as a push bar to allow a user to operate the door. The exit device 100 includes a latch 130 which projects from a top of the chassis and secures the door in an associated door frame when the latch is in the latched (i.e., extended) position. According to the embodiment of FIG. 1, when the chassis 102 is pushed toward the glass panel, the door actuator 106 engages a latch actuator (not shown) disposed in the chassis to move the latch 130 to the unlatched (i.e., retracted) position to release the door. As the chassis is pushed by the user, the push bar rotates about the first hinge 104A and the second hinge 104B to bring a portion of the push bar nearer the door actuator 106 closer to the glass panel. The latch actuator may be configured to transmit substantially linear relative motion between the chassis 102 and the door actuator 106 into motion of the latch 130. The latch actuator may include a transmission which may convert the push motion on the chassis 102 into vertical motion of a vertical rod that may be operatively coupled to the latch actuator on a first end and operatively coupled to the latch 130 on a second end. In some embodiments, the latch 130 may be biased towards the latched position with a spring or other biasing member such that the latch is retained in the latched position absent a pushing force on the chassis 102 and/or dogging of the dogging mechanism (not shown). Though the exit device 100 is shown and described as being installed on a glass pane door, the present disclosure is not limited in this regard, as the exit device 100 may be installed on a door formed of any material or combination of materials, such as wood, metal, plastic, fiberglass, and/or glass.

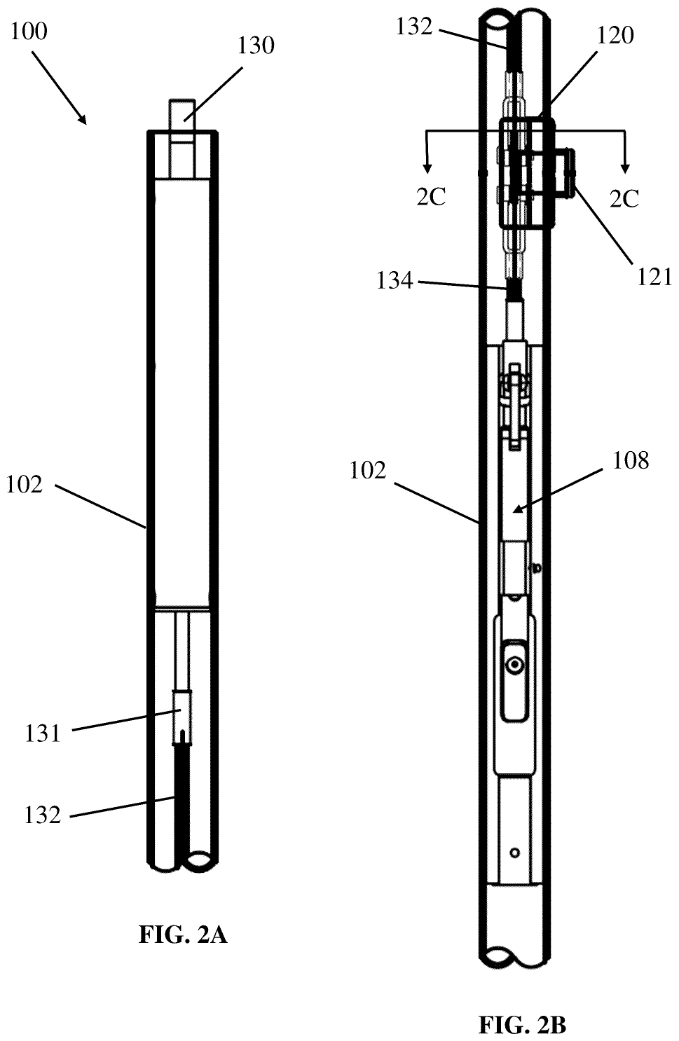

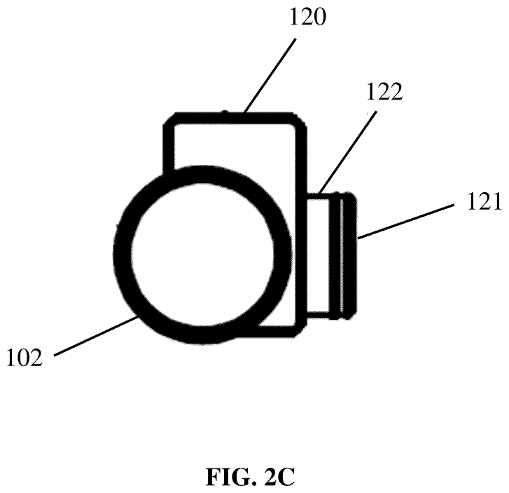

FIG. 2A shows a front schematic view of an upper section of an exit device 100 including a latch 130 that is moveable between an extended, latched position and a retracted, unlatched position. The latch 130 may be coupled to a first, upper linkage 132 via a latch coupler 131. The latch coupler 131 may be engaged with the first linkage 132 via any suitable means (e.g., a threaded connection) as the disclosure is not so limited.

FIG. 2B shows a front schematic view of a lower section of the exit device 100 of FIG. 2A. The exit device 100 includes a dogging mechanism having a cylinder 121 contained within a housing 120. As disclosed herein, a camming element may be received within the volume of the cylinder 121, and the camming element may be configured to rotate between an undogged state and a dogged state in which the latch 130 of the exit device is held in an unlatched position. The camming element may be operatively coupled with the first, upper linkage 132 and a second, lower linkage 134. The second linkage 134 may be in turn operatively coupled with a push bar. As shown in FIG. 2B, a latch actuator 108 may be contained within a chassis 102 of the push bar and configured to transmit substantially linear relative motion between the chassis 102 and the door actuator 106 (shown in FIG. 1) into motion of the latch 130 between the latched and unlatched positions. That is, actuation of the push bar to the depressed position may move the second linkage 134 downwards, thus also moving the camming element and first linkage 132 downwards to move the latch 130 to the unlatched position. Likewise, when depression on the push bar is removed, the second linkage 134 may move upwards to return to its original position, thus also moving the camming element and first linkage 132 upwards to return the latch 130 to the latched position. However, if the camming element is in the dogged state, the latch 130 may not be permitted to return to the latched position. The push bar may be of any suitable type including, but not limited to a touch bar or a cross bar, and the push bar may be of any suitable shape (e.g., the push bar may have an “L” shape as shown in FIG. 1) as the disclosure is not so limited.

FIG. 2C is a top schematic sectional view of the dogging mechanism of FIGS. 2A-B taken along lines 2C-2C. As noted above, the dogging mechanism includes a cylinder 121 received within the housing 120 which may protrude outwardly from the housing 120 as shown in FIG. 2C. The cylinder 121 and housing 120 may be disposed along any suitable portion of the push bar chassis 102 as the disclosure is not so limited. In some embodiments, the cylinder 121 may be engaged with the housing 120 via a fitting ring 122. In some embodiments, as disclosed herein, the user may provide an input to the dogging mechanism (e.g., a key) to transition a camming element within the cylinder 121 between a dogged state and an undogged state.

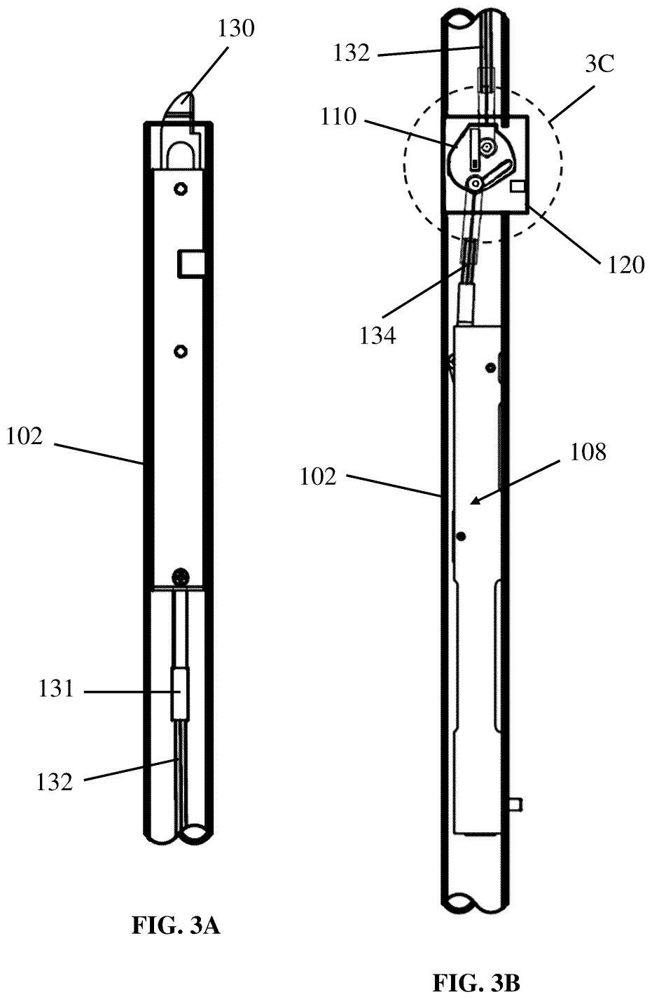

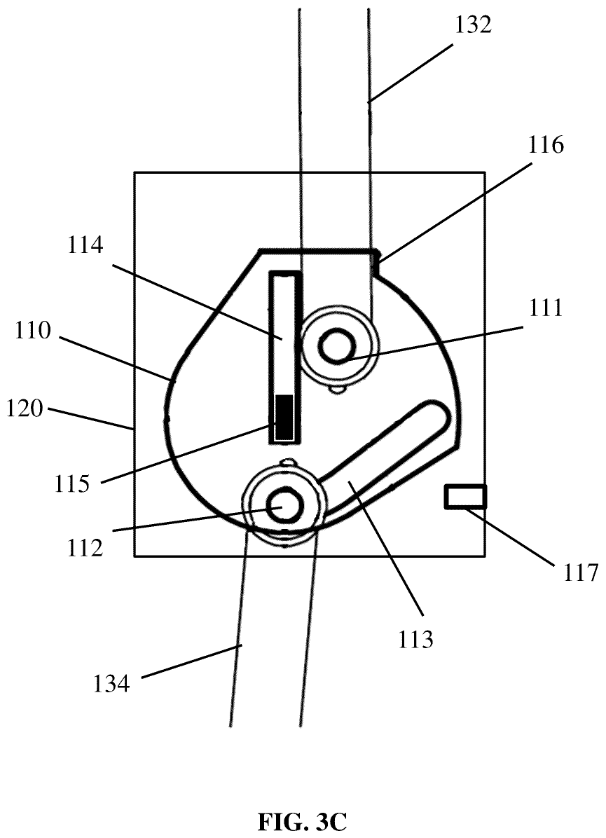

FIG. 3A and FIG. 3B show a side schematic view of the upper and lower sections of the exit device 100 of FIGS. 2A and 2B, respectively, where the dogging mechanism is shown in an undogged state. In the undogged state, the latch 130 may be in the latched position by default, and the push bar of the exit device may be depressed to move the second linkage 134, the camming element 110, and the first linkage 132 each downwards to move the latch 130 to the unlatched position. When the depression of the push bar is removed, the latch 130 may return to the latched position.

FIG. 3C shows an enlarged view of region 3C of FIG. 3B where details of the dogging mechanism in an undogged state are shown. As shown in FIG. 3C, the first linkage 132 is fixed to the camming element 110 via a pinned connection 111 such that the first linkage 132 may move vertically downwards in response to rotation of the camming element 110 from the undogged state (as shown in FIG. 3C) to the dogged state. The second linkage 134 may include a pin 112 which is configured to be received within a slot 113 of the camming element 110. The slot 113 may be at least partially curved such that the camming element may rotate relative to the pin 112 to move between the undogged and dogged positions. In some such embodiments, the pin 112 and the second linkage 134 may be configured to remain stationary while the slot 113 of the camming element rotates. The camming element 110 may also include a vertical key slot 114 configured to receive an input (e.g., a key 115) from the user such that the camming element 110 is constrained to move in a vertical direction in the undogged state in response to depression and/or release of the push bar. That is, the slot 114 of the camming element 110 may move vertically downwards relative to the key or other tool input by the user into the slot 114 when the push bar is depressed.

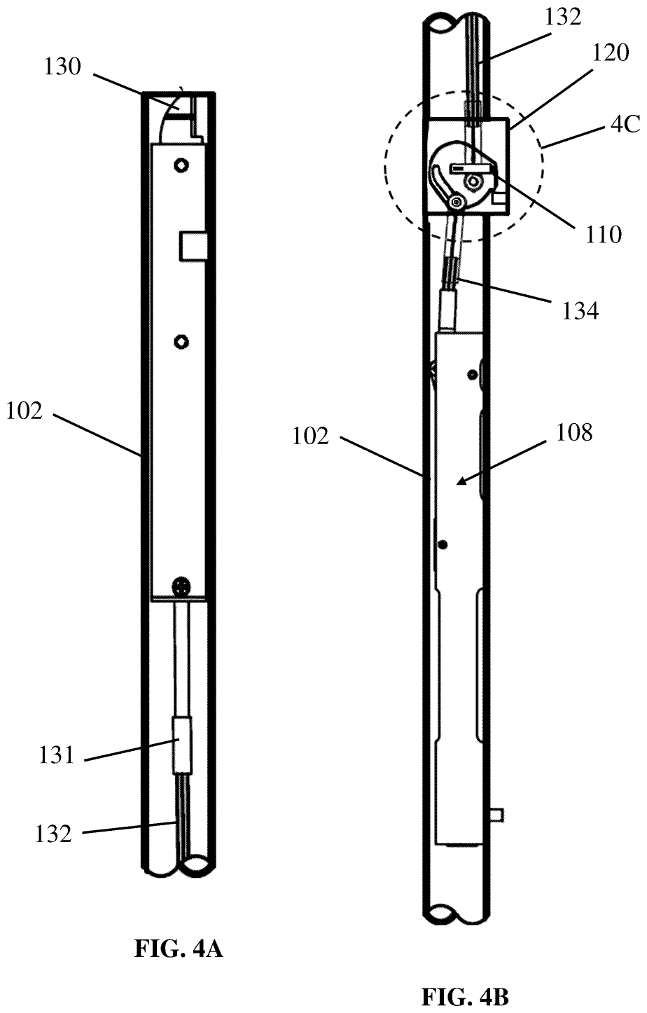

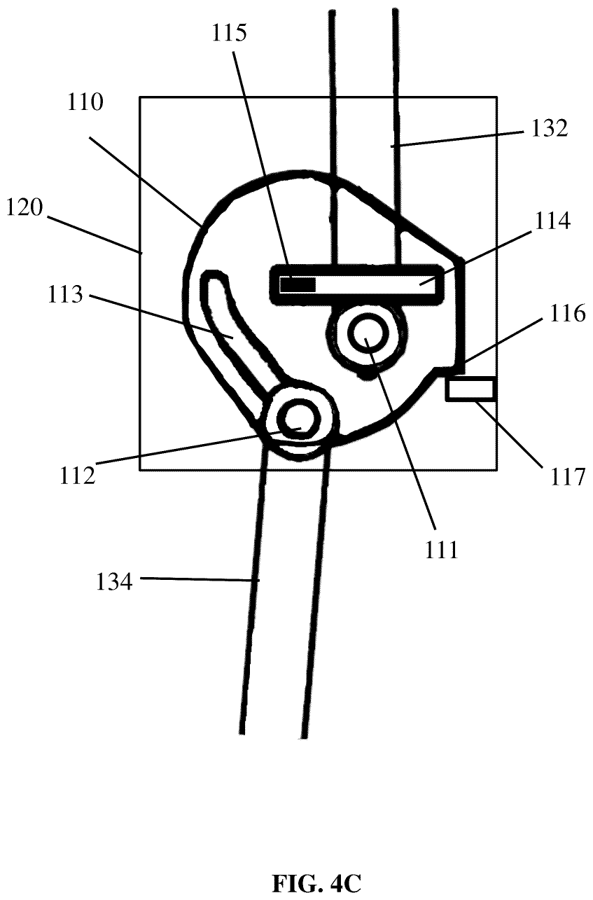

FIG. 4A and FIG. 4B show a side schematic view of the upper and lower sections of the exit device 100 of FIGS. 2A and 2B, respectively, where the dogging mechanism is shown in a dogged state. In the dogged state, the latch 130 is shown to be in the unlatched position. Specifically, rotation of the camming element 110 to the dogged state pulls the first linkage 132 downward because the first linkage 132 is fixed to the camming element 110 via the pinned connection 111, thereby retaining the latch 130 in the unlatched position.

FIG. 4C shows an enlarged view of region 4C of FIG. 4B where details of the dogging mechanism in a dogged state are shown. As shown in FIG. 4C, the camming element 110 may be rotated approximately 90 degrees clockwise such that the slot 113 may rotate relative to the pin 112 while the second linkage 134 remains stationary. In addition, rotation of the camming element 110 to the dogged state may cause the first linkage 132 to move downwards to in turn retract the latch 130. When the camming element 110 is rotated to the dogged state, the latch 130 may be retained in the unlatched position to permit push and pull of an associated door within actuation of the exit device. In particular, the user may input a key 115 into the slot 114 of the camming element, and the user may turn the key to rotate the camming element 110 to the dogged state, thus retaining the latch in the unlatched position.

The camming element 110 may also include a built-in stopping surface 116 that is configured to limit rotation of the camming element 110 when moving from the undogged state to the dogged state. Specifically, the stopping surface 116 may abut a protuberance 117 of the housing 120 to limit rotation of the camming element past a certain angle (e.g., approximately 90 degrees) when the camming element is in the dogged state. In addition, the stopping surface 116 may serve to limit depression of the push bar which may be beneficial to provide an indication to the user that the exit device is in the dogged state. In some embodiments, the stopping surface 116 may not automatically abut the protuberance 117 of the housing 120 when the device is in the dogged state. Instead, there may be an allowance between the stopping surface 116 and the protuberance such that a user may partially depress the push bar to engage the stopping surface with the protuberance. While such an example discloses the use of a protuberance extending from a portion of the housing, the amount of rotation of the camming element may be limited in any suitable fashion as the disclosure is not limited in this regard.

The embodiments described herein may be embodied as a method. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A dogging mechanism for an exit device, the dogging mechanism comprising:
a camming element configured to move between a dogged state and an undogged state;
at least one slot in the camming element to permit movement of the camming element between the dogged state and the undogged state;
a first linkage operatively coupled to a latch of the exit device, wherein the first linkage is fixed to the camming element such that movement of the camming element between the undogged state and the dogged state moves the latch between a latched position and an unlatched position, respectively; and
a second linkage operatively coupled to the camming element, wherein at least one pin of the second linkage is received within the at least one slot, wherein at least a portion of the at least one slot is curved to permit rotation of the camming element, and wherein the camming element is configured to move between the undogged state and the dogged state by moving the at least one slot relative to the second linkage.

2. The dogging mechanism of claim 1, wherein the dogging mechanism is configured to receive an input from a user to move the camming element between the undogged state and the dogged state.

3. The dogging mechanism of claim 2, wherein the user input is a key that is configured to engage a key slot of the camming element, and wherein the camming element is configured to move between the undogged state and the dogged state in response to the user turning the key in the key slot.

4. The dogging mechanism of claim 1, wherein the latch is configured to engage a corresponding door strike when in the latched position.

5. The dogging mechanism of claim 4, wherein the exit device includes a push bar, wherein the push bar is moveable between and extended position and a depressed position.

6. The dogging mechanism of claim 5, wherein the camming element includes a key slot, and wherein the key slot is configured to constrain movement of the camming element to translational movement in a vertical direction when the camming element is in the undogged state.

7. The dogging mechanism of claim 6, wherein in the undogged state depression of the push bar is configured to move the latch to the unlatched position by moving the key slot of the camming element vertically downwards relative to a tool input by the user.

8. The dogging mechanism of claim 4, wherein in the dogged state the camming element is configured to move the latch to the unlatched position by moving the first linkage vertically downwards while the second linkage remains stationary.

9. The dogging mechanism of claim 1, wherein the camming element is configured to rotate approximately 90 degrees between the dogged state and the undogged state.

10. The dogging mechanism of claim 1, further comprising a housing configured to contain the camming element.

11. The dogging mechanism of claim 10, wherein the camming element includes a stopping surface configured to limit an amount of rotation of the camming element between the undogged state and the dogged state.

12. The dogging mechanism of claim 11, wherein the stopping surface is configured to engage a protuberance on the housing to limit the amount of rotation of the camming element.
